(19) United States
(12) Patent Application Publication
(10) Pub. No.: US 2002/0156638 A1
(43) Pub. Date: Oct. 24, 2002

(54) Process for identifying shareholders of privately owned businesses who have acquired a threshold new wealth resultant from the sale of that private business

(76) Inventors: Mark G. Guedri, Middletown, VA (US); Michael W. Giancaspro, Richmond, VA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/784,164

(22) Filed: Feb. 16, 2001

(51) Int. Cl. G06F 17/60

(52) U.S. Cl. 705/1; 705/10

(57) ABSTRACT

The invention is a process for identifying, not later than a selected time after at least one of a completed sale or a proposed announced sale of at least one private business, any shareholder of the at least one private business determined to be at least potentially receiving compensation resultant from the sale of the at least one private business which exceeds a threshold shareholder compensation value. From at least one information source providing information about sales of businesses over a period of time, the completed sale or the proposed announced sale of the private business which has at least a sale value exceeding a threshold business sale value is determined. An identification of at least one shareholder of the at least one private business is determined who at least potentially will receive from the sale of the at least one private business compensation exceeding the shareholder compensation value not later than the selected time, from at least one information source pertaining to the at least one private business.

### BACKGROUND OF THE INVENTION

1. Field of the Invention

The present invention relates to processes for identifying newly wealthy shareholders resultant from the sale of private businesses.

2. Description of the Prior Art

There are numerous data sources that pertain to businesses and individuals which include:

a) News sources, company websites, databases and national government filings describing businesses sold

b) Public company stock ownership, stock option exercises and stock transactions by officers and directors that generate wealth

c) Private company databases that profile the company and identify officers and directors, but are unable to identify share ownership

d) Personal information about individuals available in the public record

e) Wealth-oriented databases using public company stock ownership, stock option exercises and stock transactions by officers and directors as the basis for identifying individuals for potential philanthropic donations, financial services and other commercial purposes

Set forth below is additional information about these data sources:

| Data Sources | Description |
|---|---|
| Businesses | |
| Sold: | |
| News sources | These general sources provide information about the |
| and company | announced sale of businesses. Availability of detailed |
| websites | transaction information is limited to public company |
| | acquisitions of either private or public businesses if the |
| | transaction is material to the acquiror. Privately owned |
| | businesses sold to publicly owned acquirors where the |
| | transaction is material represent less than 33% of private |
| | business sales. |
| Antitrust | Notifications of Early Terminations Granted for |
| Filings to | acquisitions that are not deemed by the FTC to |
| the Federal | pose an antitrust problem are posted on the |
| Trade | internet each business day. The acquiror, acquired |
| Commission | company name, seller, early termination date (if |
| (FTC) | applicable) and FTC action reports (if applicable) |
| | are included on the FTC web site. This source of |
| | businesses sold does not include transactions with |
| | proceeds less than $50 million or transactions where |
| | the early termination of antitrust review is not granted. |
| | As such, over 75% of the private businesses sold are not |
| | included in this source. For those transactions that are |
| | included in the site, transaction details are not released |
| | by the FTC |
| Deal | These sources provide the acquiror, acquired company |
| Databases | name, announcement date, acquired company address |
| (e.g., | and other publicly available information about the |
| MergerStat | transaction. Less than 33% of the transactions in |
| and Thomson | this source have transaction terms and proceeds |
| SDC) | disclosed. For private company transactions, |
| | shareholder ownership percentage is generally not |
| | available in this source or any other known source. |
| Security | These filings by public company acquirors are available |
| and | through an SEC website. The public acquiror must file an |
| Exchange | SEC Form S-4 or 8-K if the acquisition is material to its |
| Commission | business. These filings provide details about the |
| (SEC) | transaction. However, less than 33% of the private |
| Filings | company transactions with a public company acquiror |
| | are material enough to require such a filing. |
| Public | |
| Company | |
| Stock | |
| Ownership: | |
| SEC Forms | These filings are required by officers and directors of |
| 3, 4, 5 | public companies to describe company stock ownership, |
| and 144 | recent transactions and stock option exercises. The new |
| | wealth identified through this source is not related in |
| | any way to private company ownership. |
| SEC Form | These documents provide share ownership information |
| 10-K and | for officers, directors and owners of greater than 5% of a |
| Proxy | public company stock. Private company share ownership |
| Statements | is not available in this source, and is generally not |
| other | available in any other public information source. |
| Private | |
| Company | |
| Databases: | |
| (e.g., Ward's | These sources contain private company names, addresses, |
| Directory, | summary business and industry profiles, competitors, |
| Hoover's, | news releases and selected officers and directors. |
| Harris | Share ownership is not available from these sources for |
| InfoSource, | private companies. These sources are primarily used by |
| Dun & | businesses and consultants for competitive intelligence |
| Bradstreet, | and new business development directed to the target |
| CorpTech, and | company, not its shareholders. |
| One Source, | |
| etc.) | |
| Personal | |
| Information: | |
| Address and | These web-based sources provide basic contact infor- |
| Phone | mation for individuals. There is no cross-reference |
| Numbers: | available to the individuals' business or place of |
| (e.g., | employment. |
| Superpages, | |
| Yahoo | |
| People, etc.) | |
| Profile | These sources access public records in all 50 states. |
| Information: | Personal information can be obtained including, but not |
| (e.g., | limited to, vehicle registration, boat registration, real |
| USSearch.com | estate assessments, household data and buying |
| InfoUSA, | preferences. |
| Acxiom, | |
| Equifax, | |
| Claritas, etc.) | |
| Wealth- | |
| Oriented | |
| Databases: | |
| Wealthid.com | This data source tracks wealth from public company |
| | stock ownership, option exercises and stock |
| | transactions (SEC Forms 3, 4, 5 and 144 filings) for use |
| | in prospecting by philanthropic organizations and com- |
| | panies selling products and services. Wealthid.com does |
| | not address new wealth derived from the sale of privately |
| | owned businesses. |
| Who's | Registry of 112,960 of America's most prosperous |
| Wealthy in | individuals. The primary source for this list appears |
| America 2000 | to be the same SEC data described above that tracks |
| | stock ownership within publicly traded companies. This |
| | book does not address the newly wealthy from the sale of |
| | privately owned businesses. |
| Target | This source is focused on the top 5% of wealthy people |
| America | in the United States. This book does not address the |
| | newly wealthy from the sale of private companies. |
| | The 5% threshold is below the $1 million level and |
| | includes a list of approximately 13 million people. |

Several U.S. patents disclose systems for processing information

involving investment assets. See U.S. Pat. Nos. 5,806,049, 5,930,764, 5,966,695, 6,078,892 and 6,061,658. These systems do not provide information of new shareholder wealth resultant from the sale of private businesses.

Wealth-oriented databases for philanthropic and commercial prospecting purposes are centered around well-known and established wealth. Primary sources of information for these services include public company information often derived from SEC filings by officers and directors regarding their company stock ownership, stock option exercises and stock transactions.

Information surrounding the sale of businesses is gathered primarily for the use of investment banks, financial and legal advisors, commercial banks, senior corporate officers and corporate development professionals. The information is organized around the acquiring and selling companies, not the newly wealthy selling shareholders.

The information in the two most commonly used transaction-oriented databases includes:

1) Mergers and acquisitions

2) Stake purchases

3) Real Estate Investment Trust (REIT) activity

4) Asset sales and divestitures

5) Rumored and seeking buyer transactions

6) Leveraged buyouts

7) Tender offers

8) Privatizations

9) Spinoffs and splitoffs

10) Bankruptcy liquidations

11) Strategic alliances

The data elements include:

1) Target and acquiror industry, location and parent company

2) Financial advisor assignments and fees

3) Transaction value and stock premiums (if disclosed)

4) Synopsis of transaction

5) Transaction status

6) Financial information on target company and acquiror (if available)

7) Investor group information (if applicable)

8) Accounting method for transaction

The primary use of the data is:

1) Understanding transaction values for specific deals and evaluating industry valuation trends

2) Understanding transaction volume and deal flow by region and industry (SIC code)

3) Identification of comparable company transactions and valuation multiples of key financial data as a means of valuing similar companies

4) Comparison of fees and activity levels amongst financial and legal advisors (league tables)

5) Identification of active buyers of businesses

6) Identification of deal characteristics and pricing mechanisms

7) Identification of likely strategic alliance partners

8) Competitive intelligence and industry research specific to acquisitions

Other products within transaction databases include global corporate restructurings, global public finances, corporate restructures corporate governance, venture capital, industry statistics and securities trading.

Private company databases are typically focused on competitive intelligence and business development. The previously described (e.g., Hoover's, CorpTech, Ward's and Harris Infosource) profile public and private companies. Typically, the profile information includes:

1) Name and address of company

2) Estimated revenues (if available)

3) Date of control

4) Industry classification (primary SIC code) and competitors

5) Line of business

6) State of incorporation

7) Company CEO and executives (shareholder and ownership information is not available)

8) Company website

9) Ownership type (public or private)

10) Bank and accountant

11) Recent news releases and articles

Information on individuals can be purchased from a variety of on-line sources or accessed through federal, state and local government websites. The information is typically from the public domain and can be searched using web-based online services with name and address as the key selection criteria. The data on individuals may include historical information including current and past addresses, phone number, vehicle registrations, real estate assessments, household information and buying preferences.

The data on businesses sold is focused on transaction activity, valuation and description of advisors. The private company databases are focused on profiling the company's business, without reference to share ownership. The information on individuals is focused on name, address, telephone, vehicle registrations, real estate assessments, property ownership, household information and buying preferences. Wealth-oriented databases for customer and philanthropic prospecting purposes are built around well-known and established wealth and SEC reporting by insiders of ownership and transactions in shares of publicly traded securities.

### SUMMARY OF THE INVENTION

The present invention provides information identifying individuals who have newly acquired wealth resultant from the sale of a private business. The present invention combines information about the sale of a private business with personal share ownership and other personal data to identify those former private business shareholders who have acquired a net worth from the sale of their private businesses exceeding a threshold value, e.g. $2 million, to permit successful and effective marketing of high value goods and/or services. The direct marketing of high value goods and/or services is more successful the sooner the marketing is initiated to those individuals soon after they acquire new substantial wealth. The present invention identifies, in a realtime manner, the newly wealthy resultant from the sale of private businesses. The invention permits identification of shareholders of a private business shortly before or soon after closing which enhances marketing opportunities of high value goods and/or services thereto. The present invention constructs a database organized around the announcement date at which private shareholder wealth exceeding a programmable threshold will or is likely to be acquired by the sale of the private business (typically, before or soon after the closing of the private business sale). The timely origination of this data upon announcement of the proposed sale of the private business corresponds directly with the high probability of significant investments and purchases by the newly wealthy former private company shareholders. In a preferred embodiment, the present invention's database is updated with new divestitures of privately owned businesses valued in the $5-$250 million range.

Last year in the United States over 3,000 private businesses were sold with transaction values ranging from $5 million to $250 million. These sales generated over $100 billion pre-tax compensation to the shareholders. On average, there were between three and four shareholders in each private business which was sold. As a result, approximately 10,000 selling shareholders received on average an after-tax liquidity of approximately $7 million from the sale of these 3,000 private businesses.

The present invention provides a process for rapidly identifying those shareholders of private businesses which have been sold who have a net valuation resultant from the sale above a programmable threshold value, such as $2 million. The invention provides a methodology by which former private business shareholders, who have received compensation above a programmable threshold shareholder value, are rapidly identified on or before the sale of a private business which provides a unique opportunity for successful marketing of high value goods and services.

The present invention is a process for identifying former shareholders or soon to be former shareholders having or who are about to receive a substantial compensation resultant from the sale of their private business. The invention stores information about these former or soon to be former shareholders in a database that includes detailed information about these newly wealthy people. The resultant database is structured to provide market prospecting information which is specified by clients of the proprietors of this process that has not been available from traditional marketing efforts. The process of the present invention and the database utilized therein containing information pertaining to newly affluent individuals resultant from the sale of private businesses is updated on a realtime basis as private business sales are announced and ultimately completed. The present invention's ability to provide timely reporting, not later than a selected time after at least one of a sale or an announced sale of a private business, of shareholder's who have or who are about to acquire significant compensation as a result of the sale of their private businesses provides opportunities for successful marketing of high value goods and/or services which is not provided in the prior art.

Clients of the market information prepared by the present invention are comprised of large, often publicly traded companies that market products to wealthy individuals. Examples include insurance, investment products, real estate and luxury goods, such as high-end automobiles, jewelry, yachts, etc.

Clients of the database in accordance with the invention, otherwise currently advertise using traditional methods, including television, print media, purchased lists of likely buyers based on age, demographics (not differentiated by new wealth), and other standard marketing approaches. These advertising methods are not nearly as targeted as the present invention and do not specifically pinpoint new wealth.

The present invention permits clients of the database to direct different marketing techniques from traditional marketing by identifying only newly wealthy individuals resultant from the sale of a private business which in aggregate comprise over $100 billion in new wealth each year. These promptly identified newly wealthy former shareholders of a sold private business are now accessible to marketing campaigns directed to the eminent release of purchasing power from their proceeds from the recent sale of their private business.

The present invention may generate pertinent information involving the sale of private businesses of those shareholders which exceed the programmable threshold limit within a short time period, such as fifteen days after the announcement pertaining to the sale of the private business. The timeliness of this information allows businesses the opportunity to initiate contact for the purpose of providing protection for this new wealth through insurance and investment products and to sell luxury products and services to the newly wealthy individuals.

The database of the present invention allows clients of the proprietors of this process to proactively initiate commercial relationships with newly wealthy individuals prior to the sale or immediately after the completion of the sale of their private business assets before they have an opportunity to enter into relationships with other providers of competitive high value goods and/or services.

The database of the present invention contains diverse information about newly wealthy former private business owners and is used to target market high value products and/or services.

A variety of information from public companies, private companies, individuals and business transactions is available from existing public records and private sources and is used by the present invention to help identify these newly wealthy individuals who have sold their private businesses. However, several elements of the data stored in the database of the invention, such as share ownership data (actual or estimated percentage and related valuation of shares) require research of information which is captured by the present invention from sources not available in the public domain, such as, the information produced by research directed to the private company and its shareholders.

The invention is a process for identifying, not later than a selected time after at least one of a completed sale or a proposed announced sale of at least one private business, any shareholder of the at least one private business determined to be at least potentially receiving compensation resultant from the completed sale or the proposed announced sale of the at least one private business which exceeds a threshold shareholder compensation value. The process includes determining from at least one information source providing information about sales of businesses over a period of time the completed sale or the announced sale of the private business which has at least a sale value exceeding a threshold private business sale value; and determining, not later than the selected time, from at least one information source pertaining to the at least one private business an identification of at least one shareholder of the at least one private business who at least potentially will receive from the sale of the at least one private business compensation exceeding the threshold shareholder compensation value. The selected time may be after an announcement of a proposed sale or the completed sale of the at least one private business. The sale value exceeding the threshold business sale value may be determined from publicly reported transaction terms of the sale or the announced proposed sale of the at least one private business. The sale value exceeding the threshold business sale value may be estimated from data obtained from at least one source pertaining to other private businesses or national government filings, to entities such as the SEC. The at least one source pertaining to the other private businesses may store data related to a sale value of other businesses representative of the sale value of the at least one private business from which the sale value is extrapolated. The identification of the at least one shareholder may include information useful for contacting the at least one shareholder and is obtained from at least one of a website of the private company, database information or other information sources. Determining of the proposed announced sale may be from review of at least one of daily research of announced sales of businesses, at least one database providing information on announced sales of businesses, announcements from the Federal Trade Commission of Transactions Granted Early Termination resultant from antitrust filings and announcements and news releases; and all sales of public businesses obtained from the determining of the proposed announced sale may be eliminated to provide information about only private businesses sold from which the at least one private business and an acquiror thereof is identified. The identification of the at least one shareholder may be verified by at least one of a survey addressed to the at least one shareholder after the sale of the at least one private business or from other sources having information familiar with the transaction; and information in a database pertaining to the sale of the at least one private business may be updated. The information pertaining to the sale of the at least one business which is updated may involve at least potentially received compensation that at least one shareholder of the at least one private business will receive. Progress of a sale of the at least one private business may be tracked from at least one information source from a time that the announcement of the proposed sale of the private business is identified until after closing of the sale; and a valuation of at least the potentially received compensation that the at least one shareholder of the at least one private business may receive may be updated from the progress of a sale of the private business as tracked and is stored in a database. The identification of the at least one shareholder may be stored in a database storing information about shareholders of private businesses and may be processed to provide information about the at least one shareholder which is provided to businesses marketing products and/or services to persons having received compensation exceeding the threshold shareholder compensation value. Publicly available personal information may be gathered and stored in a database about the at least one shareholder which is of interest to businesses marketing products and/or services.

### BRIEF DESCRIPTION OF THE DRAWINGS

FIG. 1 illustrates a flowchart of a process in accordance with the present invention.

FIG. 2 illustrates a flowchart of a possible methodology for performing a survey in accordance with the flowchart of FIG. 1.

### DESCRIPTION OF THE PREFERRED EMBODIMENTS

The present invention is a process for identifying, not later than a selected time after at least one of a completed sale or a proposed announced sale of at least one private business, any shareholder of at least one private business determined to be at least potentially receiving compensation resultant from the completed sale or proposed announced sale of the at least one private business which exceeds a shareholder compensation value. At least one information source providing information about the sales of businesses over a period of time is used to determine the completed sale or the proposed announced sale of the at least one private business which has at least a sale value exceeding a threshold business sale value. The selected threshold business sale value is programmable and may be in a preferred embodiment, without limitation, set to be $5 million. Thereafter, not later than the selected time, an identification of at least one shareholder of the at least one private business is determined from at least one information source pertaining to the at least one private business, who at least potentially will receive from the completed sale or proposed announced sale of the at least one private business compensation exceeding the shareholder compensation value.

This information is preferably stored in a database of a group of former or soon to be former private business shareholders all of whom exceed the threshold shareholder compensation value. The database is made available on a commercial basis to businesses desirous of directing the sale of high value goods and/or services to individuals of high personal net worth which has been newly acquired which provides a maximum opportunity for target marketing. The data of the database may be processed in accordance with programmable criteria for identifying selected individuals therein having particular personal information which is requested by clients of the database so as to permit an even more selected highly specialized marketing program to selected people, e.g. people who already own an airplane or a boat are more likely to purchase a more expensive one.

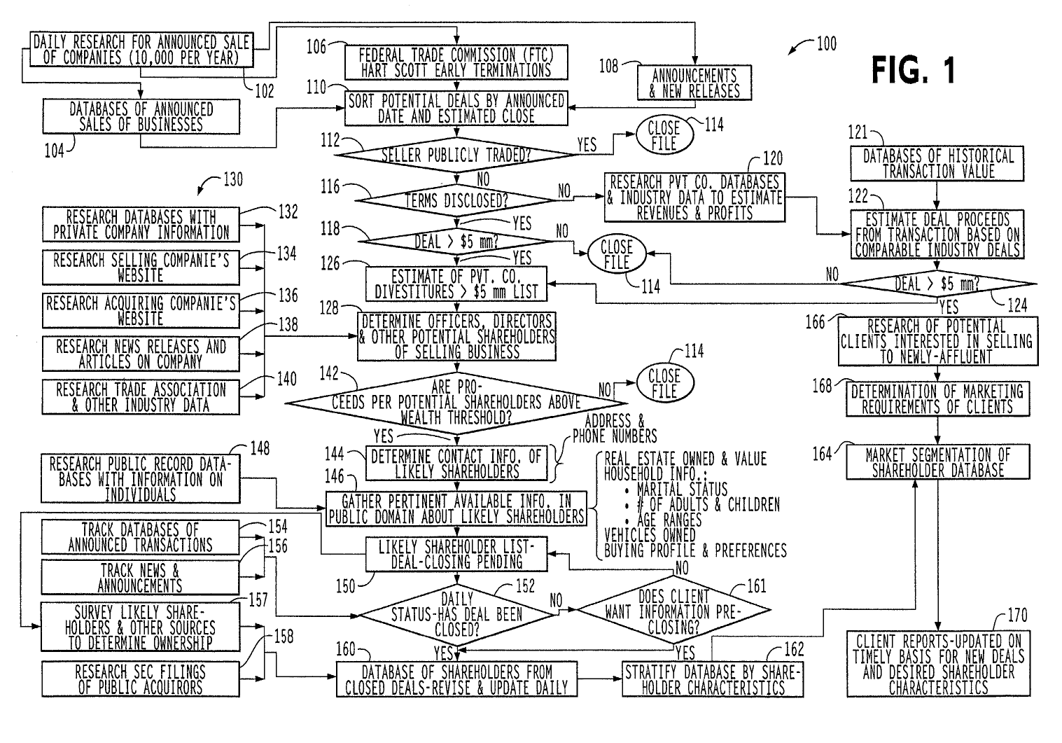

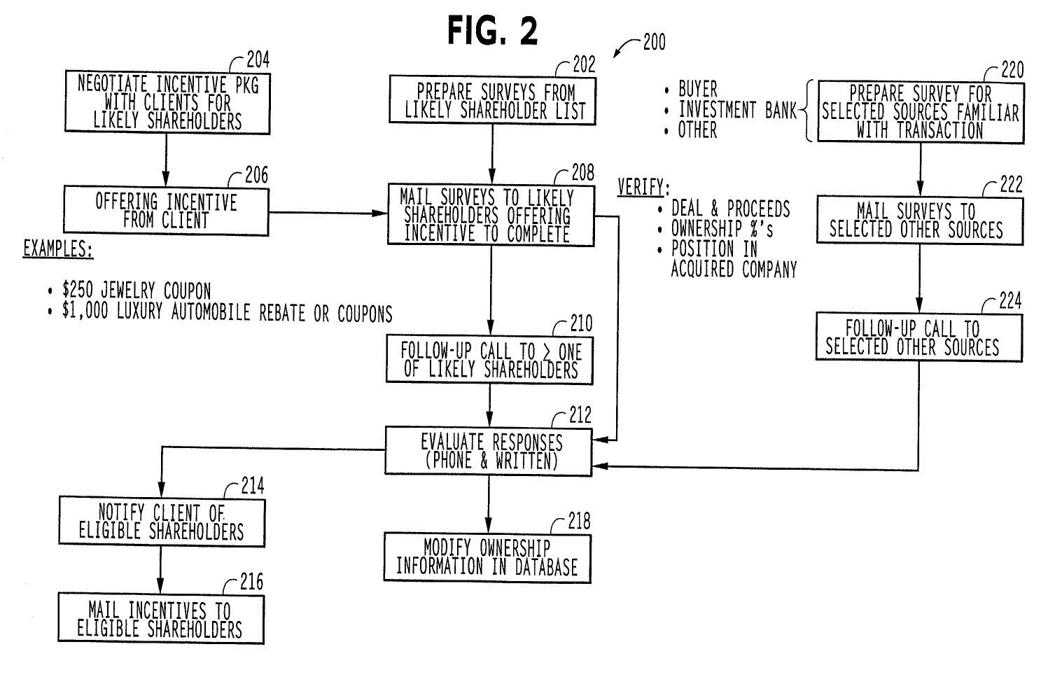

FIG. 1 illustrates the process of the invention. The process 100 of the invention starts at point 102 where daily research is conducted for announced sales of companies so as to locate therein the completed sales of over 3000 private businesses sold in the range of $5-$250 million from the approximately 10,000 announcements of proposed business sales which occur yearly in the United States. The process proceeds from the initiation of daily research at point 102 to three potential sources of information 104, 106 and 108 which respectively are databases of announced sales of businesses 104, Federal Trade Commission Transactions Granted Early Termination 106 and announcements and news releases 108 to identify daily information pertaining to the completed sale or proposed announced sales of companies. Once all of the sources 104, 106 and 108 are used to identify all possible sales of businesses, the process proceeds to point 110 where a sorting of potential transactions by announced date and estimated closing date occurs. An example of databases of announced sales of businesses 104 is MergerStat. Examples of sources of announcements and news releases 108 is Reuters, Dow Jones News and company press releases. Thereafter, the process proceeds from point 110 to decision point 112 where a determination is made if each transaction identified at point 110 is a publicly traded company. If the answer is “yes” at decision point 112, information on the particular transaction identified at point 110 is closed as indicated at point 114. The result of decision point 112 is that approximately 6,000 private transactions of interest are identified from the approximately 10,000 announced transactions. If the answer is “no” at decision point 112, the process proceeds to point 116 where a determination is made of whether the terms are disclosed. If the answer is “yes” at point 116, the process proceeds to decision point 118 where a determination is made if the potential value of the sale of the private company is above a programmable threshold. As illustrated, the threshold is $5 million but, it should be understood, that any net transaction evaluation may be used at decision point 118. If the answer is “no” at decision point 118 that the value of the potential transaction is below the threshold, such as $5 million, the process proceeds to closing at point 114. If the answer is “no” at decision point 116 that the terms are not disclosed, the process proceeds to point 120 where research of private company databases and industry data of publicly traded companies are accessed to provide information used to estimate revenues and profits of the private company to be sold (about which no terms are disclosed) from analogous sales of public or private companies which provide a reliable basis for extrapolating the value of the transactions. The process proceeds to point 122 where the actual estimation of the total value of the sale of the private company is extrapolated based on comparable historical industry transaction values obtained from point 121 combined with the private company and industry information provided by the research at point 120. The process proceeds to decision point 124 where a determination is made if the value of the private sale exceeds the programmable threshold which again is programmed to be $5 million as at decision point 118. However, as stated with regard to decision point 118, the threshold may be set to any value. If the value of the transaction as determined at point 124 is less than the threshold, such as $5 million, the file is closed at point 114. On the other hand, if the value of the transaction, as determined at point 114, is above the threshold, the process proceeds to point 126 where the value of the private company transaction which is determined to exceed the threshold is added to the database. The processing proceeds to point 128 which receives an input from point 126 and input from various research data sources 130. The research databases include databases with private company information 132, the selling company's website 134, the acquiring company's website 136, news releases and articles on the private company being sold 138, and trade association and other industry association data 140, all of which research databases 130 along with the company identification produced at point 126 are used to determine the officers, directors and other potential owners of the selling business at point 128. The process proceeds to decision point 142 where a determination is made if the proceeds for each shareholder for the sale of the private business will result in at least one shareholder having a net wealth above a programmed threshold, such as, but not limited to, $2 million. If the answer is “no” at decision point 142, the file is closed at point 114. On the other hand, if at least one shareholder is determined to have a potential value as determined at decision point 142 above the programmable threshold, the process proceeds to point 144, where contact information of each likely shareholder having a net value as a result of the sale of the private business above the programmed threshold, as set at point 142, is determined with such information including address and phone numbers. The information for contacting the at least one shareholder may be obtained from at least one website of the private company, database information either with or without charge, or other information sources with or without charge. The process proceeds to point 146 where gathering of pertinent available information in the public domain about likely shareholders occurs. The gathering which occurs at point 146 is based upon research of public record databases with information on individuals, including the likely shareholders, as inputted from point 148. The pertinent available information determined at point 146, without limitation, includes real estate owned and its value, household information such as, but not limited to, the marital status, number of adults and children and age ranges, vehicles owned and buying profile and preferences. The process proceeds to point 150 where a likely shareholder list and a determination if the closing of the pending transaction now has a set date. The process proceeds to decision point 152 where a daily status determination is undertaken to determine if the transaction has been closed. Databases of announced transactions 154 and news and announcements 156 are inputted to the decision point 152 to permit determination of whether the transaction has been closed. Furthermore, the likely shareholder list and whether the transaction closing date is a pending matter, as identified at point 150, is inputted to point 157 where a survey of likely shareholders and other sources is made to determine ownership of the private company which is to be sold. Such a survey may be without limitation in accordance with FIG. 2 as described below. Furthermore, research of SEC filings of public acquirors is conducted at point 158. Sources 156 and 158 are inputted to a database of shareholders from closed transaction, which is revised and updated daily as indicated at point 160. Point 160 is also entered from decision point 152 when a determination of transaction closings has been identified. The process proceeds to decision point 161 from decision point 152 where a determination is made of whether the client wants information available prior to closing. If the answer is “no” at decision point 161, the process proceeds back to point 150. If the answer is “yes” at decision point 161, the process proceeds to point 160 where database 160 is updated to identify that selected clients want information stored in the database prior to closing. The process proceeds from point 160 to point 162 where sorting or stratification of the information in the database is conducted by shareholder characteristics to provide information tailored to particular customer requirements regarding marketing information to commercial entities desirous of marketing high value goods and/or services to wealthy individuals identified as shareholders who have or who will receive compensation above the programmable threshold as indicated at point 142. The stratification of the database and tailoring to particular client requirements at point 162 is also inputted to market segmentation of shareholder database at point 164 which also receives processing from researching of potential clients interested in selling to newly affluent at point 166 which is an input to the determination of marketing requirements of clients at point 168 which is an input to point 164. The process proceeds from point 164 to point 170 where client reports are updated in the database on a timely basis for information regarding new transactions which includes the outputting of reports identifying shareholders who qualify with wealth above the threshold set above 142 and have desired shareholder characteristics.

The reports are tailored to client specific requirements. The clients may create a direct marketing program and brochures to accompany the continuously updated reports that contain the prospective newly wealthy customers. The database can be sorted to provide any combination of newly wealthy profile information and reports including, but not limited to:

1) Level or range of new wealth

2) Geographic region of primary residence

3) Current ownership of certain assets that may predict future purchases (.e.g, boats, airplanes, automobiles, second homes, etc.

4) Assessed value of primary residence

5) Martial status, age ranges within household and number of children in the household

6) Buying preferences (e.g., international travel, luxury cruises, etc.)

The client reports produced at point 170 pertaining to shareholders of at least one private business which has been sold are produced within a selected time after at least one of a sale or an announced sale of the at least one business.

FIG. 2 illustrates a flowchart of one possible way of performing surveys at point 157 of FIG. 1 of shareholders who are projected to receive compensation above the threshold determined at point 142 of FIG. 1. The shareholder survey 200 proceeds from point 202 where a survey is prepared from the likely shareholder list as previously identified. Additionally, an incentive package is negotiated with clients, as indicated at point 204, who wish to market goods or services to likely shareholders of the private company which has been sold. At point 206, the potential incentive from the client is included in the mailing to enhance the potential shareholder response rate. At point 208, surveys are mailed to likely shareholders which offer the incentive negotiated at point 204 to complete the survey. The survey process proceeds to point 210 where follow-up call(s) are made to at least one of the likely shareholders to obtain responsive information asked for by the survey. The call may include a request to fill out the survey and a discussion of the incentives offered by the client who wishes to market services to the shareholder so as to interest the shareholder by the inducement of the incentives to provide the information regarding his or her valuation received under the sale of a private company. The process proceeds to point 212 where an evaluation of the response secured by the call at point 210 and any written information which has been obtained by receipt of the survey is conducted. The process proceeds to point 214 where the client, who has offered the incentive, is notified of the eligible shareholders who are likely to purchase the goods or services being offered by the client. The process proceeds to point 216 where incentives to the eligible shareholders are mailed by the client to complete the offering of the incentives. The process proceeds from point 212 to point 218 where the ownership information in the database described in association with FIG. 1 is modified based upon the responses obtained at point 212.

Alternatively, instead of the preparation of surveys based upon incentives, surveys may be prepared for selected sources familiar with the transaction as indicated at 220. Such sources may be a buyer, investment banker or other. At point 222, the surveys are mailed to the selected other sources to verify the transaction and proceeds, ownership percentages, position in the acquired company, etc. of the shareholders who are projected to exceed the threshold value. The process proceeds to point 224 where a follow-up call to the selected other sources is made in order to obtain information which is inputted to the evaluation of responses at point 212 discussed above.

### EXAMPLE

Point in FIG. 1 The following is an example of the process of the present invention:

Description of workflow

| | |
|---|---|
| 104 | On a daily basis, access external databases to determined |
| | all announcements of pending sales of businesses from the |
| | previous day (Example - Jan. 31, 2001). Our research |
| | indicates that there are approximately 25-30 such |
| | announcements each day in the United States alone. |
| 108 | Find and read all deal announcements from newswires or |
| | company websites (buyer or seller web sites) |
| 110 | Sort all January 31 announced transactions by estimated |
| | closing date of sale in the announcement |
| 112, 114 | Eliminate sales of businesses where the target is publicly |
| | traded (ticker symbol in announcement) |
| 116 | From announcements, determine which transactions have |
| | terms disclosed including transaction proceeds. |
| 116, 120 | Example: Acme Manufacturing - privately owned business |
| | to be purchased by publicly traded XYZ Technologies, Inc. |
| | (NYSE: XYZ). Detailed terms are not disclosed, but |
| | closing is estimated to be Feb. 28, 2001 in Acme |
| | and XYZ announcements on Jan. 30, 2001. |
| 122 | External databases are accessed to find sales of businesses |
| | in Acme's industry classification that have similar |
| | characteristics. |
| 121, 122 | Compare Acme's financial condition and operating results to |
| | similar businesses that recently sold |
| 121, 122 | Example: Acme's proceeds from XYZ at closing are |
| | estimated at $31 million determined by valuation analysis |
| | and extrapolation from comparable transactions in an |
| | external (a database from other than the proprietor's of this |
| | process) database. |
| 124, 126 | Add Acme to the database since the estimated proceeds of |
| | $31 million are greater than $5 million |
| 132, 134, | Research is conducted of company websites and various |
| 136, 138, | external databases to determine Acme's officers, directors, |
| 140 | founders and other individuals that are likely to be significant |
| | shareholders of Acme. |
| 128 | Three potential shareholders are identified (President and |
| | Chief Executive Officer - Chris Donaldson, Chief Operating |
| | Officer - Michael Wallace and retired founder - Mark |
| | Gunderson). |
| 142 | Based on the $31 million estimated deal proceeds (122) and |
| | the three likely shareholders (128), it is estimated that each |
| | shareholder will easily exceed the minimum individual wealth |
| | threshold of $1 million. As such, Donaldson, Wallace and |
| | Gunderson are retained in the database as soon-to-be newly |
| | affluent individuals as a result of selling their business. |
| | For simplicity, this example hereinafter only describes the |
| | process steps applied to Donaldson even though Wallace and |
| | Gunderson would also be included in the database. |
| 144, 148 | For Donaldson, research directories and public record |
| | databases and determine contact information (home address |
| | and telephone number). |
| 146, 148 | With the address and telephone information, access |
| | external direct marketing databases (from public record |
| | sources) to determine profile information: |
| | Chris Donaldson |
| | 1234 Oak Lane |
| | Anywhere, North Carolina 77991 |
| | 998-893-3131 (telephone) |
| | Married |
| | Age range (50-54) |
| | Spouse - Eleanor |
| | Age range (45-49) |
| | Children (two) |
| | Age ranges (10-12, and 14-16) |
| | Primary residence tax assessment: $279,000 |
| | Vehicles owned: 1998 Cadillac Seville, 1997 Ford Taurus |
| | Boat owner: 1994 Hatteras - 24 ft. length |
| | Frequent international traveler |
| 150 | At this time all of the Chris Donaldson information is added |
| | into the database of soon-to-be newly wealthy individuals. |
| | Current date for this example is Feb. 4, 2001 (4 days |
| | elapsed time from proposed deal announcement and 24 days |
| | before estimated closing date of February 28). |
| 154, 156 | Deal closing announcement is found on XYZ's company |
| | website on February 27 |
| | Research of XYZ's Securities & Exchange Commission |
| | (SEC) filing regarding this deal reveals that the actual |
| | purchase price was $32 million (determined on March 2) |
| 160 | The database is updated to reflect higher deal proceeds and |
| | higher estimated shareholder proceeds to Donaldson |
| 157 and | A survey is sent to Donaldson, Wallace and Gunderson and |
| | other parties involved in the transaction to verify XYZ/ |
| Flowchart | Acme deal proceeds and Acme shareholder ownership. Survey |
| | results or telephone follow-up confirms the $32 million deal |
| | proceeds and reveals that Donaldson owned 25% of the |
| | Acme shares ($8 million pre-tax proceeds), Gunderson |
| | owned 50% of the shares ($16 million pre-tax proceeds), |
| | Wallace owned 20% of the shares ($6.4 million pre-tax |
| | proceeds) and two other previously unidentified |
| | shareholders owned the remaining 5% of the shares. |
| 160 | The database is updated for SEC filing information |
| | (158) and survey information (157 as fully described |
| | in FIG. 2). Elapsed time of example - Mar. 3, 2001, 4 days |
| | after closing. |
| 162, 164, | The database is stratified based on its clients' specific |
| 166, 168 | requirements (e.g., new wealth greater than $6 million, |
| | current boat owners, selected current vehicle information, |
| | age range, etc.) to pinpoint targeted shareholder lists |
| | that meet their very specific direct marketing requirements. |
| 170 | Client, Gerrill Fynch (GF), requests weekly update of the |
| | shareholder database for its use in targeting newly wealthy |
| | individuals to market its investment management |
| | products and services. GF's contract with the proprietors |
| | of this process specifies information for all shareholders |
| | with new wealth estimated at $6 million or greater organized |
| | by geography to facilitate marketing by the nearest GF |
| | office. Donaldson's profile ($8 million new wealth) is |
| | included on the North Carolina prospect list for GF as part |
| | of its direct marketing efforts to pinpoint new wealth. It |
| | is very important to GF that they contact all newly wealthy |
| | individuals like Donaldson on a timely basis to attempt to |
| | secure these potential new customers before major invest- |
| | ment decisions are made with GF's competitors. |
| 170 | Similarly, information is provided to other clients interested |
| | in Donaldson including a major boat manufacturer/retailer, a |
| | luxury car retailer in Donaldson's city and a major |
| | insurance company (estate planning and specialty insurance |
| | products and services). |

The process of the present invention is implemented with the use of a computer network, including at least one processor and a memory, which contains at least one database as described above. The network is preferably connectable on-line to the information sources discussed above. Many of the process steps of FIG. 1 are implemented with the at least one processor of the network in response to the information inputs discussed above. The present invention's process steps may be implemented with diverse types of software.

While the invention has been described in terms of its preferred embodiments, it should be understood that numerous modifications may be made thereto without departing from the spirit and scope of the invention. It is intended that all such modifications fall within the scope of the appended claims.

1. A process for identifying, not later than a selected time after at least one of a completed sale or a proposed announced sale of at least one private business, any shareholder of the at least one private business determined to be at least potentially receiving compensation resultant from the sale of the at least one private business which exceeds a threshold shareholder compensation value comprising:
determining from at least one information source providing information about sales of businesses over a period of time the completed sale or the proposed announced sale of the private business which has at least a sale value exceeding a threshold business sale value; and
determining, not later than the selected time, from at least one information source pertaining to the at least one private business, an identification of at least one shareholder of the at least one private business who at least potentially will receive from the sale of the at least one private business compensation exceeding the threshold shareholder compensation value.

2. A process in accordance with claim 1 wherein:
the selected time is after the announced proposed sale of the at least one private business.

3. A process in accordance with claim 1 wherein:
the selected time is after the completed sale of the at least one private business.

4. A process in accordance with claim 1 wherein:
the sale value exceeding the threshold business sale value is determined from publicly reported transaction terms of the completed sale of the at least one private business.

5. A process in accordance with claim 1 wherein:
the sale value exceeding the threshold business sale value is determined from publicly reported transaction terms of the proposed announced sale of the at least one private business.

6. A process in accordance with claim 2 wherein:
the sale value exceeding the threshold business sale value is determined from publicly reported transaction terms of the completed sale of the at least one private business.

7. A process in accordance with claim 2 wherein:
the sale value exceeding the threshold business sale value is determined from publicly reported transaction terms of the proposed announced sale of the at least one private business.

8. A process in accordance with claim 3 wherein:
the sale value exceeding the threshold business sale value is determined from publicly reported transaction terms of the completed sale of the at least one private business.

9. A process in accordance with claim 3 wherein:
the sale value exceeding the threshold business sale value is determined from publicly reported transaction terms of the proposed announced sale of the at least one private business.

10. A process in accordance with claim 1 wherein:
the sale value exceeding the threshold business sale value is estimated from data obtained from at least one source pertaining to other private businesses or national government filings.

11. A process in accordance with claim 2 wherein:
the sale value exceeding the threshold business sale value is estimated from data obtained from at least one source pertaining to other private businesses or national government filings.

12. A process in accordance with claim 3 wherein:
the sale value exceeding the threshold business sale value is estimated from data obtained from at least one source pertaining to other private businesses or national government filings.

13. A process in accordance with claim 10 wherein:
the at least one source pertaining to the other private businesses stores data related to a sale value of other businesses representative of the sale value of the at least one private business from which the sale value is extrapolated.

14. A process in accordance with claim 11 wherein:
the at least one source pertaining to the other private businesses stores data related to a sale value of other businesses representative of the sale value of the at least one private business from which the sale value is extrapolated.

15. A process in accordance with claim 12 wherein:
the at least one source pertaining to the other private businesses stores data related to a sale value of other businesses representative of the sale value of the at least one private business from which the sale value is extrapolated.

16. A process in accordance with claim 1 wherein:
the identification of the at least one shareholder includes information useful for contacting the at least one shareholder and is obtained from at least one of a website of the private company, database information or other information sources.

17. A process in accordance with claim 2 wherein:
the identification of the at least one shareholder includes information useful for contacting the at least one shareholder and is obtained from at least one of a website of the private company, database information or other information sources.

18. A process in accordance with claim 3 wherein:
the identification of the at least one shareholder includes information useful for contacting the at least one shareholder and is obtained from at least one of a website of the private company, database information or other information sources

19. A process in accordance with claim 4 wherein:
the identification of the at least one shareholder includes information useful for contacting the at least one shareholder and is obtained from at least one of a website of the private company, database information or other information sources

20. A process in accordance with claim 10 wherein:
the identification of the at least one shareholder includes information useful for contacting the at least one shareholder and is obtained from at least one of a website of the private company, database information or other information sources

21. A process in accordance with claim 11 wherein:
the identification of the at least one shareholder includes information useful for contacting the at least one shareholder and is obtained from at least one of a website of the private company, database information or other information sources

22. A process in accordance with claim 12 wherein:
the identification of the at least one shareholder includes information useful for contacting the at least one shareholder and is obtained from at least one of a website of the private company, database information or other information sources

23. A process in accordance with claim 13 wherein:
the identification of the at least one shareholder includes information useful for contacting the at least one shareholder and is obtained from at least one of a website of the private company, database information or other information sources

24. A process in accordance with any one of claims 1-23 wherein:
(a) determining of the announced sale is from review of at least one of daily research of announced sales of businesses, at least one database providing information on announced sales of businesses, announcements from the Federal Trade Commission of Transactions Granted Early Termination resultant from antitrust filing and announcements and news releases; and
(b) all sales of public businesses obtained from step (a) are eliminated to provide information about only private businesses sold from which the at least one private business and an acquiror thereof is identified.

25. A process in accordance with claims 1-23 wherein:
the identification of the at least one shareholder is verified by at least one of a survey addressed to the at least one shareholder after the sale of the at least one private business or from other sources having information familiar with the transaction; and
information in a database pertaining to the sale of the at least one private business is updated.

26. A process in accordance with claim 25 wherein:
the information pertaining to the sale of the at least one business which is updated involves at least potentially received compensation that at least one shareholder of the at least one private business will receive.

27. A process in accordance with claims 1-23 wherein:
progress of a sale of the at least one private business is tracked from at least one information source from a time that the announcement of sale of the private business is identified until after closing of the sale; and
a valuation of at least the potentially received compensation that the at least one shareholder of the at least one private business will receive is updated as the progress of a sale of the private business as tracked and is stored in a database.

28. A process in accordance with any one of claims 1-5, 10, 13 and 16 wherein:
the identification of the at least one shareholder is stored in a database storing information about shareholders of private businesses and is processed to provide information about the at least one shareholder which is provided to businesses marketing products and/or services to persons having received compensation exceeding threshold value shareholder compensation.

29. A process in accordance with any one of claims 10-13 wherein:
the governmental filings are with the SEC.

30. A process in accordance with any one of claims 16-23 wherein:
publicly available personal information is gathered and stored in a database about the at least one shareholder which is of interest to businesses marketing products and/or services.
